(19) United States
(12) Patent Application Publication
(10) Pub. No.: US 2026/0278228 A1
(43) Pub. Date: Sep. 17, 2026

(54) SYSTEMS, METHODS, AND COMPUTER READABLE MEDIA FOR BEHAVIORAL MODELLING OF POWER AMPLIFIERS UNDER MODULATED OPERATING CONDITIONS

(71) Applicant: Keysight Technologies, Inc., Santa Rosa, CA (US)

(72) Inventors: Jan Maria Petrus Verspecht, Santa Rosa, CA (US); Talley Amir, New York, NY (US); Osamu Kusano, Santa Rosa, CA (US)

(21) Appl. No.: 19/552,783

(22) Filed: Feb. 27, 2026

Related U.S. Application Data
(63) Continuation-in-part of application No. 18/649,359, filed on Apr. 29, 2024.

(51) Int. Cl. G06F 30/3308; G06F 111/10; H03F 3/21

(52) U.S. Cl. CPC G06F 30/3308; G06F 2111/10; H03F 3/21

(57) ABSTRACT

A system for modeling loadpull behavior of a power amplifier under modulated operating conditions includes a model extractor for receiving as inputs measured values on an amplifier output signal b_{2,ref}(t) for different reference load impedances and an load impedance emulating signal a₂(t) used to emulate the reference load impedances, and extracting a model of loadpull behavior of the power amplifier that assumes memory effects are accounted for in instantaneous measurements of the output signal b_{2,ref}(t). The system further includes a loadpull behavior predictor for using the models generated for the different reference load impedances to predict behavior of the power amplifier under operating load impedances within predetermined distances of the reference load impedances.

### PRIORITY CLAIM

This application is a continuation-in-part of U.S. patent application Ser. No. 18/649,359, filed Apr. 29, 2024, the disclosure of each which is incorporated herein by reference in its entirety.

### TECHNICAL FIELD

The subject matter described herein relates to methods, systems, and computer readable media for behavioral modelling of circuits and, in particular, to modeling loadpull behavior of power amplifiers.

### BACKGROUND

Users of electronic devices, such as power amplifiers, desire to simulate the behavior of the power amplifiers in designing circuits that utilize the power amplifiers. Simulating the behavior of a power amplifier requires an accurate model to model the behavior of the power amplifier under different operating conditions, such as different load impedances. Power amplifiers are not typically shipped with digital models of their behavior, so the models must be determined experimentally. Determining models of power amplifier behavior is a challenging task due to power amplifier memory effects that show up with modulated input signals and variations in output impedance. Power amplifier behavior that changes with output impedance is referred to as loadpull behavior. These behaviors are difficult to model.

Accordingly, in light of these and other difficulties, there exists a need for improved methods, systems, and computer readable media for modeling loadpull behavior of power amplifiers.

### SUMMARY

A method for modeling loadpull behavior of a power amplifier under modulated operating conditions includes receiving, as inputs, measured values of an amplifier output signal b_{2,ref}(t) for a plurality of different reference load impedances and a load impedance emulating signal a₂(t) used to emulate the reference load impedances. The method further includes extracting, for each of the reference load impedances, a model of loadpull behavior of the power amplifier that assumes memory effects are accounted for instantaneous measurements of the amplifier output signal b_{2,ref}(t); and using the models generated for the different reference load impedances to predict behavior of the power amplifier under load impedances within predetermined distances of the reference load impedances.

According to another aspect of the subject matter described herein, the method for modeling loadpull behavior of a power amplifier includes generating and applying an input signal a₁(t) to an input terminal of the power amplifier, generating and applying the load impedance emulating signal a₂(t) for each of the reference load impedances to an output terminal of the power amplifier, and measuring an output signal b_{2,ref}(t) at the output terminal of the power amplifier.

According to another aspect of the subject matter described herein, the method for modeling loadpull behavior of a power amplifier includes varying the load impedance emulating signal a₂(t) to emulate the plurality of different reference load impedances by selecting the different reference load impedances corresponding to different expected operating impedances of the power amplifier.

According to another aspect of the subject matter described herein, extracting the model for each of the reference load impedances includes extracting coefficients of a polynomial model for each of the reference load impedances.

According to another aspect of the subject matter described herein, the polynomial model comprises a Volterra polynomial model.

According to another aspect of the subject matter described herein, the predetermined distances are differences in magnitudes and phases between the reference load impedances for each model and the operating load impedances being modeled.

According to another aspect of the subject matter described herein, the predetermined distances are measurable using a Smith chart.

According to another aspect of the subject matter described herein, using the models generated for the different reference load impedances to predict behavior of the power amplifier under operating load impedances within predetermined distances of the reference load impedances includes, for an operating load impedance for which behavior of the power amplifier is being predicted, selecting a model corresponding to a reference load impedance having a closest distance to the operating load impedance of the power amplifier.

According to another aspect of the subject matter described herein, using the models generated for the different reference load impedances to predict behavior of the power amplifier under operating load impedances within predetermined distances of the reference load impedances includes, for a gamma load trace representing operating load impedances for a plurality of different frequencies, computing a vector average impedance of the gamma load trace, and selecting a model corresponding to a reference load impedance having a closest distance to the vector average impedance.

According to another aspect of the subject matter described herein, a system for modeling loadpull behavior of a power amplifier under modulated operating conditions is provided. The system includes a computing platform including at least one processor and a memory. The system further includes a model extractor implemented by the at least one processor for receiving, as inputs, measured values on an amplifier output signal b_{2,ref}(t) for a plurality of different reference load impedances and a load impedance emulating signal a₂(t) used to emulate the reference load impedances and extracting a model of loadpull behavior of the power amplifier that assumes memory effects are accounted for in instantaneous measurements of the amplifier output signal b_{2,ref}(t). The system further includes a loadpull behavior predictor implemented by the at least one processor for using the models generated for the different reference load impedances to predict behavior of the power amplifier under load impedances within predetermined distances of the reference load impedances.

According to another aspect of the subject matter described herein, the system includes a signal generator for generating and applying an input signal a₁(t) to an input terminal of the power amplifier and for generating and applying the load impedance emulating signal a₂(t) to an output terminal of the power amplifier.

According to another aspect of the subject matter described herein, the system includes a network analyzer for measuring the amplifier output signal b_{2,ref}(t).

According to another aspect of the subject matter described herein, the signal generator is configured to vary the load impedance emulating signal a₂(t) to emulate the plurality of different reference load impedances by selecting the different load impedances corresponding to different expected operating impedances of the power amplifier.

According to another aspect of the subject matter described herein, the model comprises a polynomial model.

According to another aspect of the subject matter described herein, the polynomial model comprises a Volterra polynomial model.

According to another aspect of the subject matter described herein, the predetermined distances are differences in magnitudes and phases between the reference load impedances for each model and the operating impedances being modeled.

According to another aspect of the subject matter described herein, the predetermined distances are measurable using a Smith chart.

According to another aspect of the subject matter described herein, the model extractor is configured to, for an operating load impedance for which behavior of the power amplifier is being predicted, select a model corresponding to a reference load impedance having a closest distance to the operating load impedance of the power amplifier.

According to another aspect of the subject matter described herein, the loadpull behavior predictor is configured to, for a gamma load trace representing operating load impedances for a plurality of different frequencies, compute a vector average impedance of the gamma load trace, and select a model corresponding to a reference load impedance having a closest distance to the vector average impedance.

According to another aspect of the subject matter described herein, a non-transitory computer readable medium having stored thereon executable instructions that when executed by a processor of a computer control the computer to perform steps is provided. The steps include receiving, as inputs, measured values on an amplifier output signal b_{2,ref}(t) for a plurality of different reference load impedances and a load impedance emulating signal a₂(t) used to emulate the reference load impedances. The steps further include extracting, for each of the reference load impedances, a model of loadpull behavior of the power amplifier that assumes memory effects are accounted for in instantaneous measurements of the output signal b_{2,ref}(t). The steps further include using the models generated for the different reference load impedances to model behavior of the power amplifier under load impedances within predetermined distances of the reference load impedances.

The subject matter described herein may be implemented in software in combination with hardware and/or firmware. For example, the subject matter described herein may be implemented in software executed by a processor. In one example implementation, the subject matter described herein may be implemented using a non-transitory computer readable medium having stored therein computer executable instructions that when executed by the processor of a computer control the computer to perform steps. Example computer readable media suitable for implementing the subject matter described herein include non-transitory devices, such as disk memory devices, chip memory devices, programmable logic devices, field-programmable gate arrays, and application specific integrated circuits. In addition, a computer readable medium that implements the subject matter described herein may be located on a single device or computer platform or may be distributed across multiple devices or computer platforms.

### BRIEF DESCRIPTION OF THE DRAWINGS

The subject matter described herein will now be explained with reference to the accompanying drawings of which:

FIG. 1 is a block diagram of an example system for computer aided design (CAD) of circuits, such as phased antenna arrays having power amplifiers;

FIG. 2 is a block diagram illustrating an example behavioral modelling approach using a cascade of blocks;

FIG. 3 is a block diagram illustrating an artificial neural network;

FIG. 4 is a screen shot of an example screen from a graphical user interface of an automated circuit design tool;

FIG. 5 is a block diagram of an example method for designing a circuit using an automated design tool;

FIG. 6 is a block diagram illustrating a topological overview of the sequential behavioral model;

FIG. 7 illustrates an exemplary hardware setup for wideband active loadpull measurements;

FIG. 8 is a Smith chart illustrating model extraction (gray) and validation (black) gamma load measurements, as well as reference (red);

FIG. 9 illustrated graphs of modeling results;

FIG. 10 is a Smith chart illustrating model extraction (gray) and validation (black) load traces for a multiple reference impedances experiment;

FIG. 11 illustrates Normalized Mean Square Error (NMSE) of measured versus predicted b₂(t) using different reference impedances;

FIG. 12 illustrates NMSE of measured versus predicted b₂(t) using different reference impedances with the reference impedances shown in uppermost graph in FIG. 12;

FIG. 13 illustrates partitioning of validation data into subsets according to reference used for prediction;

FIG. 14 illustrates NMSE of measured versus predicted b₂(t) using best reference for each measurement in validation set;

FIG. 15 is a block diagram of a system for modeling loadpull behavior of a power amplifier under modulated operating conditions; and

FIG. 16 is a flow chart illustrating a method for modeling loadpull behavior of a power amplifier under modulated operating conditions.

### DETAILED DESCRIPTION

The output load of the amplifiers in an active antenna array depends on the steering angle, and behavioral models often do not include this dependency. One exception is X-parameters, but this behavioral modelling approach does not include memory effects and, as such, the model loses accuracy as the modulation bandwidth increases. This document describes methods, systems, and computer readable media to add load-pull capability to existing behavioral models, for example, the Dynamic Gain or Memory Polynomial model.

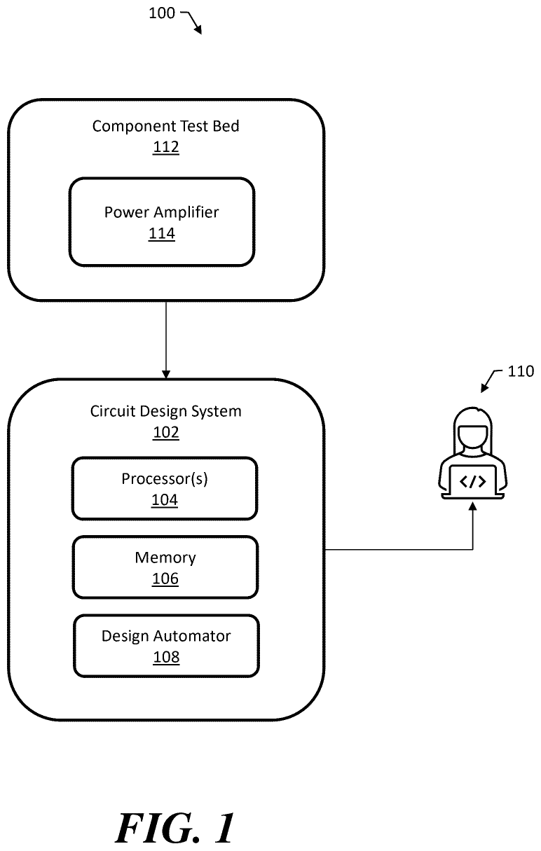

FIG. 1 is a block diagram of an example system 100 for computer aided design (CAD) of circuits such as phased antenna arrays having power amplifiers. The system 100 includes a circuit design system 102 having one or more processors 104, memory 106 storing instructions for the processors 104, and a design automator 108 implemented on the processors 104. A circuit designer 110 or other appropriate person can use the circuit design system 102, e.g., through a display and a user interface.

The system 100 includes a component test bed 112 configured to take measurements of a power amplifier 114. The component test bed 112 can include any appropriate testing hardware for characterizing the power amplifier 114 for behavioral modelling. Typically, the component test bed 112 applies various signals to the power amplifier 114 and measures the output of the power amplifier 114.

In some examples, the component test bed 112 includes a vector signal generator (VSG) as the signal source. The VSG can provide a well-defined stimulus signal, typically a continuous wave (CW) or a modulated carrier, with adjustable power level, frequency, and modulation parameters. A directional coupler can split the VSG output into two paths. One path would directly connect to the input of the power amplifier 114. The other path would serve as the reference for power measurements.

In some examples, a variable attenuator placed before the power amplifier 114 allows for precise control of the input power level. A bias network can provide the necessary DC voltages and currents to set the power amplifier 114 in the desired operating point. The output of the power amplifier 114 can be connected through, e.g., a low-pass filter to dampen any unwanted harmonics. The filtered output signal would then be fed to a power sensor for measurement. The reference path signal can, in some cases, be attenuated and filtered before reaching a second power sensor for a differential power measurement.

In operation, the circuit designer 110 specifies the design of a circuit including one or more instances of the power amplifier 114, and the design automator 108 performs a simulation of the circuit under one or more modulated operating conditions. Performing the simulation includes modeling one or more memory effects of the power amplifier 114 and modeling one or more mismatch conditions of the power amplifier 114 under the modulated operating conditions.

The circuit being designed can be a phased array antenna, and the modulated operating conditions can include a changing beam angle of the phased array antenna. Modelling one or more memory effects of the power amplifier can include modelling at least one time-varying transfer characteristic of a relationship between an input to the power amplifier and an output of the power amplifier based on a recent signal history, i.e., the aforementioned memory effects. Modelling one or more mismatch conditions can include modelling a situation where an impedance of an output of the power amplifier does not match an impedance of an input of the phased array antenna.

In some examples, performing the simulation of the circuit (and one or more instances of the power amplifier 114) includes modelling a cascade of blocks. Modelling the cascade of blocks can include modelling a behavioral model into 50 Ohms. Modelling the cascade of blocks can include modelling a load dependent X-parameter block.

Modelling the X-parameter block can include using a matched output as a reference. Modelling the X-parameter block can include using a neural network to identify the X-parameter block. Modelling the X-parameter block can include implementing the X-parameter block using frequency division duplexing (FDD).

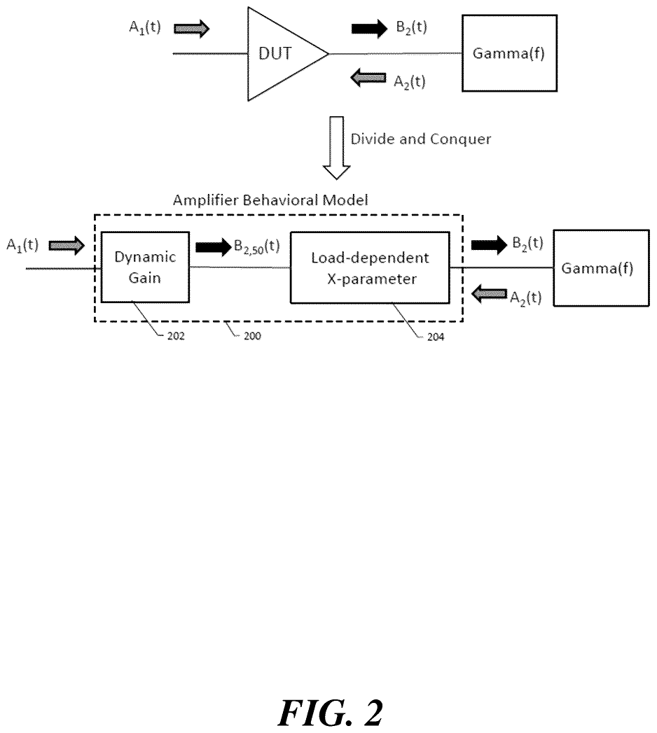

FIG. 2 is a block diagram illustrating an example behavioral modelling approach using a cascade of blocks 200. The cascade of blocks 200 for the amplifier behavioral model can include, for example, a dynamic gain block 202 and a load-dependent X-parameter block 204.

The modelling approach assumes that all the nonlinear memory effects are in the amplification process of the incident complex envelope signal A₁(t), and that the interaction between the reflected A₂(t) and the amplifier output is nonlinear but static. That is, A₁(t) is a complex vector representing the amplitude and phase of the modulated input signal as a traveling wave. These assumptions enable a solution that is based on using the formalism of the load-dependent X-parameters. The model equation is as follows.

$${B}_{2} ( t ) = {X}_{F} ( \vert {B}_{2 , 50} ( t ) \vert , \qquad ( 1 )$$

$$Re ( {A}_{2} ( t ) {P ( t )}^{- 1} ) ,$$

$$Im ( {A}_{2} ( t ) {P ( t )}^{- 1} ) ) P ( t )$$

$$P ( t ) = exp ( 𝒿 φ ( {B}_{2 , 50} ( t ) ) ) \qquad ( 2 )$$

$${B}_{2 , 50} ( t ) = \hat{M} [ {A}_{1} ( t ) ] \qquad ( 3 )$$

with B₂(t) the complex envelope representation of the pseudo-wave representing the voltage wave emanating from the amplifier, A₂(t) the complex envelope representation of the pseudo-wave representing the voltage wave reflected from the load, and with B_{2,50}(t) representing the output signal into a perfectly matched load, assuming the load has an impedance of 50 Ohms that matches the output impedance of the amplifier being modeled. Thus, the signal B_{2,50}(t) depends only on A₁(t), including past values of A₁(t), and does not depend on A₂(t), because A₂(t) is not present for a perfectly matched load. The relationship between B_{2,50}(t) and A₁(t) is described by the functional \hat{M}[.].

This functional \hat{M}[.] can be described by any behavioral modelling technique, such as a Dynamic Gain model. The goal of behavioral modeling of a power amplifier as described herein is to accurately model B₂(t), given B_{2,50}(t) and A₂(t) as model inputs.

Note that the main difference with the X-parameter formulation is that the formulation uses B_{2,50}(t) as the reference signal, rather than A₁(t). This provides an elegant way to divide and conquer the behavioral model identification as we can treat the determination of the function X_{F}(., ., .) and the functional M[.] as completely independent problems. M[.] captures the nonlinear memory effects of the amplification process, and X_{F}(., ., .) captures the nonlinear, yet static, interaction with the arbitrary load.

The functional M[.] can be identified by any appropriate method. The function X_{F}(., ., .) is defined on the 3-dimensional input space formed by the real variables |B_{2,50}(t)|, Re(A₂(t)P(t)−1), and Im(A₂(t)P(t)−1). Any experiments with the goal of identifying the function will need to cover this 3-dimensional space. Since B_{2,50}(t) typically corresponds to the response of the amplifier to a pseudo-random modulated signal with both amplitude and phase modulation, the quantity |B_{2,50}(t)| will cover a range of amplitudes from close to zero to a peak value, B_{2,MAX}, and P(t) will completely cover the unit circle. If the function is extracted in a simulated experiment, we can easily generate any arbitrary A₂(t), and there are plenty of possibilities to create an experiment that sufficiently covers the input space. If we perform a measurement-based extraction, such an experiment can be performed by using 2 vector signal generators, one for generating A₁(t) and one for generating A₂(t). A simpler and less costly approach exists whereby one generates a set of continuous-wave (CW) signals for A₂(t).

Such a measurement requires only one vector signal generator (for generating A₁(t)) and one CW synthesizer (for generating A₂(t)). One CW stimulus signal corresponds to sampling the X_{F}(., ., .) function on a cylinder, whereby B_{2,MAX} represents the height of the cylinder, and the constant amplitude of the CW A₂(t) represents the radius of the cylinder. The complete input space can be sampled by repeating this experiment for a range of amplitude values, which would typically range from 0 to B_{2,MAX}. Note that the measured B₂(t) with applying an amplitude equal to zero for A₂(t) corresponds to the measured value for B_{2,50}(t).

Once all the data samples are acquired, a multidimensional curve fit is performed, and the fitted function X_{Ffit}(., ., .) can be used as the behavioral model to represent the amplifier load-pull behavior in a simulator. A neural network can be used as the multidimensional curve fitter.

A particular issue that arises with the measurement-based model extraction is phase alignment. Each time the network analyzer acquires the phases of all measured spectra, there is one arbitrary phase offset and phase slope that is present for all the measured waves. This is caused by the arbitrary phase of the local oscillator of the VNA receivers, and by the arbitrary delay in the ADC data acquisition. This arbitrary phase slope and offset is common for all measured waves. This arbitrary phase offset and phase slope causes an issue with the model extraction as the extraction depends on measuring P(t).

Consider that we first perform a measurement of B_{2,50}(t). This is done by not injecting any A₂(t), or equivalently A₂(t)=0. We also measure the corresponding A₁(t), which we call A_{1,50}(t).

Next, we apply several A₂(t) signals that are different from zero (CW or modulated) and we measure the corresponding waveforms A₁,i (t), A₂,i (t), and B_{2,i}(t), with subscript “i” referring to the experiment with index “i”. In the following we will use index 0 to refer to the measurement whereby A₂(t)=0. We refer to the measured versions of these waveforms as A_{M1,i}(t), A_{M2,i}(t), and B_{M2,i}(t). Each experiment has its own arbitrary delay τᵢ and arbitrary phase offset θᵢ, whereby we define the reference measurement the one with index “0”. This implies that θᵢ=0 and τᵢ=0.

The measured waves are then expressed by the following equations:

$${A}_{M 1 , i} ( t ) = {A}_{1 , i} ( t - {τ}_{i} ) {e}^{j {θ}_{i}} \qquad ( 4 )$$

$${B}_{M 2 , i} ( t ) = {B}_{2 , i} ( t - {τ}_{i} ) {e}^{j {θ}_{i}} \qquad ( 5 )$$

$${A}_{M 2 , i} ( t ) = {A}_{2 , i} ( t - {τ}_{i} ) {e}^{j {θ}_{i}} \qquad ( 6 )$$

It is assumed in the following that the amplifier has perfect isolation, or that the vector signal generator has a perfect match, such that:

$${A}_{1 , i} ( t ) = {A}_{1} ( t ) . \qquad ( 7 )$$

In other words, changing the load conditions on the output of the amplifier does not change the input signal A₁(t). The model extraction is based on fitting the function X_{F}(., ., .) and requires the determination of Pi (t) with

$${P}_{i} ( t ) = {B}_{2 , 50 , i} ( t ) . \qquad ( 8 )$$

The problem is that B_{2,50,i}(t) is not a true measurable quantity, but rather a virtual one as it refers to the B₂(t) one would measure if A_{2,i}(t) would be equal to zero (but it is not). Conceptually one can write, however,

$${B}_{2 , 50 , i} ( t ) = {B}_{2 , 50} ( t - {τ}_{i} ) {e}^{j {θ}_{i}} \qquad ( 9 )$$

We conclude that B_{2,50,i}(t) can be determined indirectly by applying (9) once we know τᵢ and θᵢ.

Both τᵢ and θᵢ are determined by aligning A_{M1,i}(t) with A_{M1,0}(t). This alignment can be achieved by using any appropriate algorithm. Consider, for example, the following algorithm.

First, do not apply an A₂(t) signal and measure B_{2,50}(t) and A_{1,50}(t). Next, apply different A₂(t) signals and measure A_{M1,i}(t), A_{M2,i}(t), and B_{M2,i}(t). For each experiment, with index “i”, determine τᵢ and θᵢ by aligning A_{M1,i}(t) with A_{M2,i}(t). Next, calculate the time aligned and phase compensated quantities B_{2,50,i}(t), which are given by (9). Finally, use the quantities B_{2,50,i}(t), A_{M2,i}(t), and B_{M2,i}(t) to fit the function X_{F}(., ., .).

The Enhanced Poly Harmonic Distortion (EPHD) model, which can be considered as an extension of a load-dependent X-parameter model, has at least four major differences with the model described in this document. These differences can cause inaccuracies for practical applications, which are solved with the models described in this document.

A first difference is that the model is extracted based on the use of a set of CW excitations for the input signal A₁. Such a CW excitation fails to properly stimulate any nonlinear memory that is present in the amplifier, like for example self-heating, self-biasing or trapping effects. Such nonlinear memory effects can play a significant role in how the amplifier responds to load-pull conditions.

A second difference is that the model is expressed as a static function of the input signals A₁(t) and A₂(t), rather than as a static function of B_{2,50}(t) and A₂(t), as we do with our innovative approach. This has major consequences as none of the memory effects that are typically present in the amplification process are captured by the EPHD approach, whereas these are captured by using B_{2,50}(t) as the reference waveform, as we do with the new method.

A third difference is that the model is developed as a polynomial in A₂(t). Such a polynomial model typically has difficulties describing hard nonlinear behavior which occurs when the amplifier is saturating.

A fourth difference is the extrapolation capability versus power. It is expected that the EPHD model will extrapolate poorly if the instantaneous amplitude of A₁(t) at the input of the amplifier exceeds the maximum amplitude level of A₁(t) that was used during the model extraction.

With the methods and systems described in this document, we do not have this problem as the input to the function is not A₁(t), but B_{2,50}(t). Because of the saturation effect, the amplitude of B_{2,50}(t) is limited and the model, if characterized under saturated operating conditions, will not need to be evaluated with an amplitude of B_{2,50}(t) that is significantly higher than what was experienced by the model while being extracted.

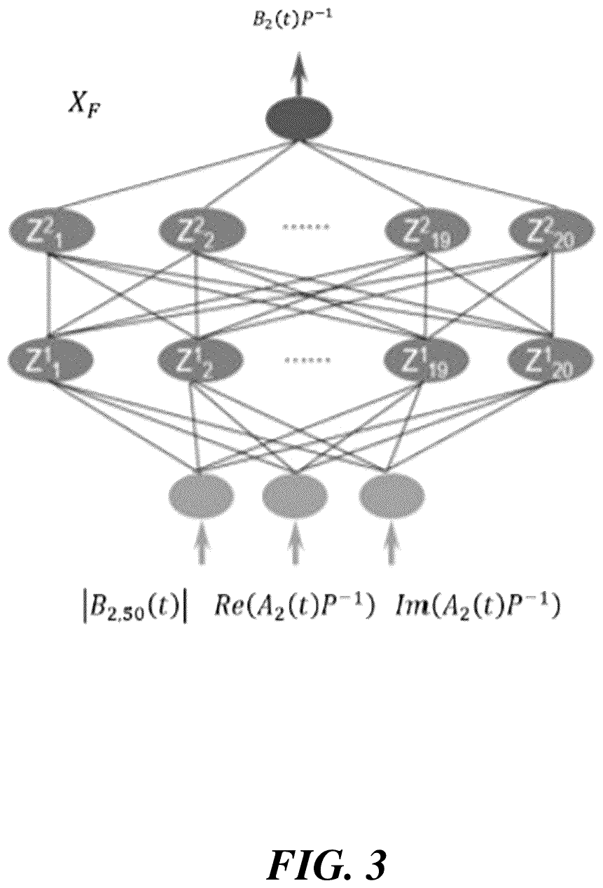

FIG. 3 is a block diagram illustrating an artificial neural network being used to extract X_{F}. In some cases, a generic ANN library can be used to generate a formula to represent discrete data.

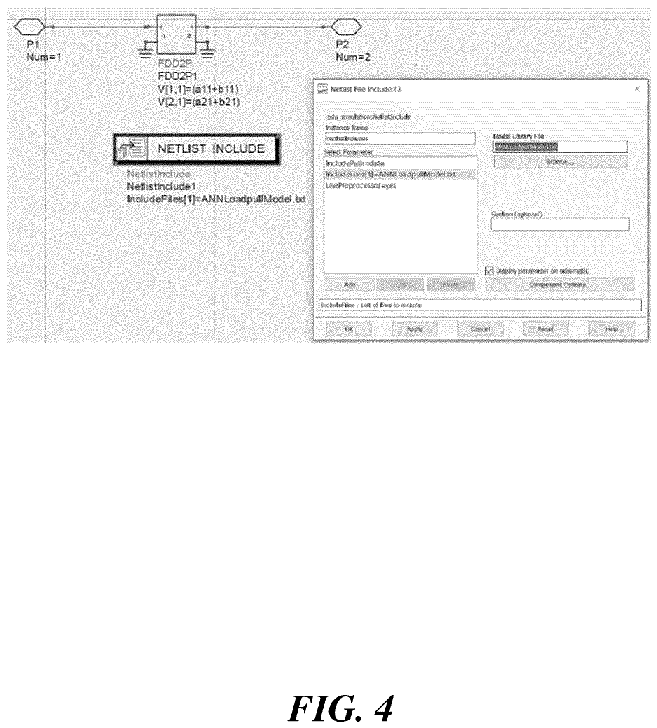

FIG. 4 is a screen shot of an example screen from a graphical user interface of an automated circuit design tool. The example screen shows a circuit schematic for a circuit being designed with a power amplifier. The behavior model is configured using a graphical user interface element (a window with text boxes) so that a simulation of the circuit can use the behavioral model of the power amplifier as described above.

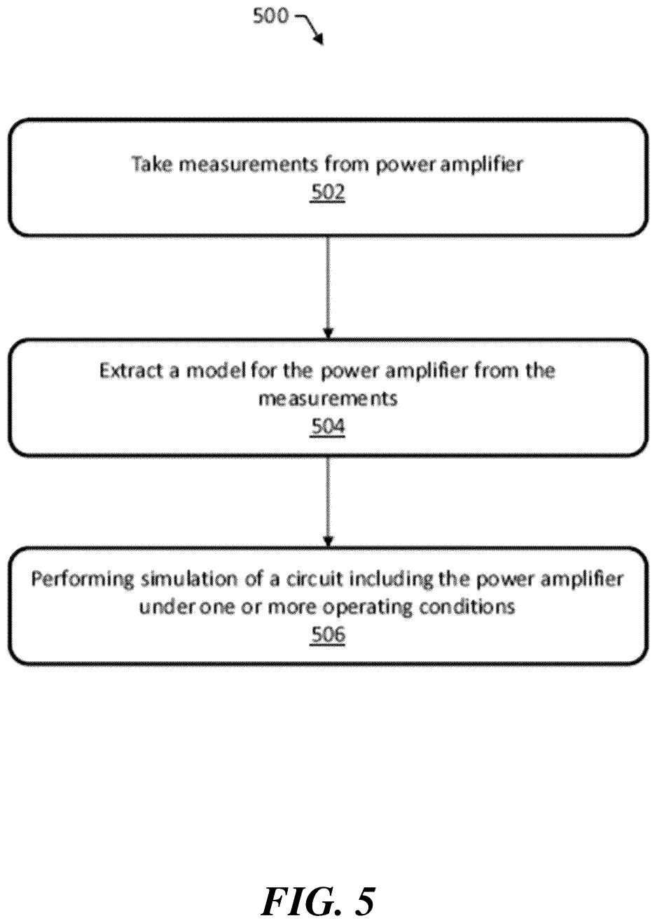

FIG. 5 is a block diagram of an example method 500 for designing a circuit using an automated design tool.

The method 500 includes taking measurements from a physical instance of a power amplifier, for example, in a test bed (502). The method 500 includes extracting a model for the power amplifier from the measurements (504). The method 500 includes performing simulation of the circuit including one or more simulated instances of the power amplifier under one or more operating conditions (506).

The circuit can be, for example, a phased array antenna, and the one or more modulated operating conditions can include a changing beam angle of the phased array antenna. Modelling one or more memory effects of the power amplifier can include modelling at least one time-varying transfer characteristic of a relationship between an input to the power amplifier and an output of the power amplifier based on a recent signal history. Modelling one or more mismatch conditions can include modelling a situation where an impedance of an output of the power amplifier does not match an impedance of an input of the phased array antenna.

In some examples, performing the simulation of the circuit (and one or more instances of the power amplifier) includes modelling a cascade of blocks. Modelling the cascade of blocks can include modelling a behavioral model into 50 Ohms. Modelling the cascade of blocks can include modelling a load dependent X-parameter block.

Modelling the X-parameter block can include using a matched output as a reference. Modelling the X-parameter block can include using a neural network to identify the X-parameter block. Modelling the X-parameter block can include implementing the X-parameter block using a frequency domain dependent device (FDD).

In the approach described above with respect to FIG. 3, an artificial neural network is used to extract the multi-dimensional model of power amplifier behavior. Training an artificial neural network to model a multi-dimensional behavior is a time- and processor-intensive process. Instead of using an artificial neural network, the multi-dimensional behavior of a power amplifier can be modeled using a polynomial fitting algorithm, such as Volterra polynomials. It is also more desirable to model power amplifier behavior at impedances that are closer to those that will be experienced by the physical power amplifier in operation, rather than assuming a perfectly matched load of 50 ohms. These additions to the power amplifier modeling methodology will now be described in more detail.

Our aim is to characterize the behavior of power amplifiers under modulated operating conditions and mismatched load impedance. The device output is altered by the amplification process via memory effects caused by thermal variations and biasing transients and by loadpull which is caused by impedance mismatch. Empirical results demonstrate that the combined effects of memory and loadpull differ over varying load conditions, requiring careful management of the separation of the analysis of these two forms of non-linear distortion.

Although loadpull behavior and memory effects appear to be intrinsically linked, we have found that separating the analysis of these two sources of distortion yields accurate predictive results in contained regions within the Smith chart. In order to model the behavior of the device output, we first extract the memory effects of the device from measured data and then describe loadpull behavior as a function of these measured traces. This separation assumption is described in detail above, but empirical results have provided an additional insight that the separation assumption only holds within limited zones of the Smith chart. Furthermore, when restricted to one of these zones, the loadpull behavior can be simplified to a polynomial expression in terms of the memory-containing reference measurements. In the following sections, we describe the procedure for performing this modeling capability which has relatively simple hardware setup, measurement procedure, and analysis technique.

### Method Overview

Our modeling approach is summarized by the following steps:
Separate the analysis of nonlinear behavior in power amplifiers into two parts: memory effects and loadpull
Simplify the model of this behavior by assuming that memory effects are caused by the amplification process, and therefore loadpull is static and separable from memory effects
focus only on fundamental frequency behavior
Frame loadpull behavior as being relative to measurements taken at some fixed reference impedance; and
model this behavior by applying a linear regression to Volterra kernels which are a function of the reference impedance and the reflection at the output of the device.

### Separation Assumption

The joint study of memory effects and impedance variation in the context of the behavioral modeling of power amplifiers is highly complex, particularly under modulated operating conditions. The difficulty in simultaneously modeling both phenomena has historically been overcome by introducing simplifications to the problem via modeling assumptions.

One such simplification is to consider only continuous waveform (CW) stimuli. Though this makes for a much more manageable problem, CW inputs do not stimulate the DUT in the same way as do modulated waveforms. For example, the power level of a constant CW input affects the temperature of the device, resulting in thermal effects which impact the DUT behavior. With increasing modulation bandwidths and higher carrier frequencies rising in demand, CW stimuli are becoming an even less sensible approximation of the application setting.

Various modern machine learning techniques have been used to capture complex device behavior under modulated operating conditions [1], but these solutions require parameter tuning and long training periods to achieve reasonable predictive accuracy.

Another methodology is to use a divide-and-conquer approach, whereby memory and loadpull are modelled separately and then the models are joined together. This technique is referred to as the Two-Path Memory Model (TPM) [4]. The TPM model separates the analysis of memory effects and load variation into two tractable subproblems. Various previous works have explored this model and proposed innovative ways to procure measurements to apply the model to actual devices under test (DUTs) [4]. In reference [4] a two-stage procedure (sweeping amplitude over (IKI) is used to extract a model for memory effects, referred to as long-term memory (LTM). Two different LTM kernels are used to describe this memory. A separate amplitude and frequency sweep is then used to learn the loadpull behavior, referred to as short-term memory (STM). All these models are then joined together to describe the behavior of the device, encompassing both long term memory effects and loadpull variation.

We manage this problem by presupposing that contributions to amplifier behavior from memory effects and impedance variations are separable via the following assumptions:
Fundamental frequency behavior is sufficient to analyze the device
Memory effects are attributed to the amplification process
Reflections due to load impedance mismatch interact with the amplifier output in a static way
   We validate these assumptions by applying our separate analyses of memory effects and load impedance variations and comparing the results to measured data.

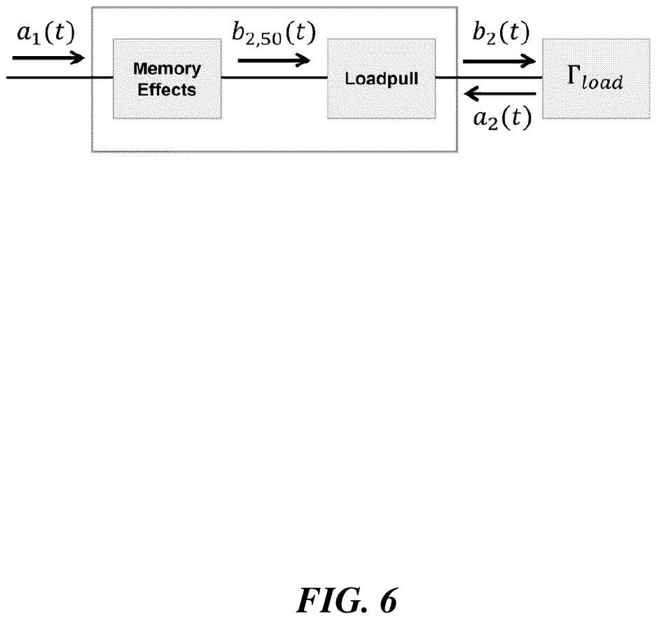

Unlike the other approaches mentioned above, we assume that memory effects are exclusively associated with the amplification process, whereas loadpull is an interaction which occurs strictly at the output of the device. Therefore, our approach considers the effects of these two phenomena in sequence of one another (in contrast with the TPM model which considers them in parallel), as illustrated in FIG. 6

As shown in FIG. 6, we suppose that memory effects can be learned first, and then loadpull behavior can be modelled compositely with these memory effects.

We first characterize the memory effects of the device when terminated into a fixed load, which we arbitrarily choose to be exactly 50 Ohms. We encapsulate this behavior in a variable called b_{2,50}(t), which can be understood as the measured output power wave b₂(t) when terminated into a load of 50 Ohms:

$${b}_{2 , 50} ( t ) = \hat{M} [ {a}_{1} ( \cdot ) ] ( t )$$

Our focus is on characterizing static loadpull behavior relative to this b_{2,50}(t) variable. Thus, we consider b_{2,50}(t) to be a measured quantity, but various methods for modeling memory effects can be used in place of M to extract b_{2,50}(t) from measured a₁(t).

By our assumption, the memory effects are already carried by, so the output b₂(t) wave is solely a function of the instantaneous a₂(t) and b_{2,50}(t). We can then describe b₂(t) terms of how it varies from b_{2,50}(t) as follows:

$${b}_{2} ( t ) = X ( {a}_{2} ( t ) , {b}_{2 , 50} ( t ) )$$

When the device is compressed, this function x can be non-linear. While Volterra kernels are not comprehensive enough to model the full behavior (including memory effects) of a power amplifier, our measurements demonstrate that a 7^{th} order Volterra polynomial is sufficient to model this function, describing the behavior of b₂(t) in terms of a₁(t) and b_{2,50}(t). Thus, loadpull effects can be described by a polynomial transformation “on top of” the memory effects:

$${b}_{2} ( t ) = X ( {a}_{2} ( t ) , {b}_{2 , 50} ( t ) ) = {\sum }_{{( i - j ) + ( k - l ) = 1 ,}_{n ϵℕ , 2 n + 1 \leq 7}^{i + j + k + l = 2 n + 1 ,}} {{α}_{i , j , k , l} ( {a}_{2} ( t ) )}^{i} {( \text{?} ( t ) )}^{j} {( {b}_{2 , 50} ( t ) )}^{k} {( \text{?} ( t ) )}^{l}$$

$$\text{?} \text{indicates text missing or illegible when filed}$$

where i+j+k+l=2n+1 enforces that the degree of the polynomial is at most 2n+1≤7
n∈ [symbol] means that only odd-degree terms are used, and
(i−j)+(k−l) specifies that we only consider fundamental frequency behavior.

One difference between the subject matter described herein and existing work is that our behavioral model evaluates the effects of memory and loadpull in sequence of one another. This presupposes both that loadpull behavior is static and that loadpull is an interaction which occurs only at the output of the device after the amplification process. These assumptions allow us to simplify our modeling and analysis techniques. By first encapsulating thermal and transient effects into 62,50 (t), we can analyze only how loadpull effects cause the output spectrum to deviate from that which is terminated into some standard impedance (which need not necessarily be 50 Ohms). A key consequence of our model is that loadpull behavior can be described by a straightforward polynomial expression when we consider only how the output of the device deviates from the same measurements into a 50 Ohm load. Our model and predictions are extremely efficient as they rely only on linear regression of polynomial terms.

### Model Improvements: Multiple Reference Points

As mentioned previously, loadpull behavior and memory effects are inherently tied to one another, which makes any separation assumption limited in accuracy. Drastic changes to the impedance match at the output of the power amplifier result in changes to the amount of power injected into the device (consider, for example, the difference in power seen by the device for a perfectly matched load versus an open), which clearly causes variations in memory behavior due to thermal effects. However, our measurements demonstrate that the separation assumption upholds when we apply our method to impedance conditions that are relatively close to the reference impedance.

We thus use multiple references to perform our method. For each reference load, we apply the polynomial fitting to the training data, which includes the reference measurement b_{2,ref}(t), and extract the model coefficients {α_{i,j,k,l}^{ref}} corresponding to this reference:

$${b}_{2} ( t ) = X ( {a}_{2} ( t ) , {b}_{2 , ref} ( t ) ) = {\sum }_{{( i - j ) + ( k - l ) = 1 ,}_{n ϵℕ , 2 n + 1 \leq 7}^{i + j + k + l = 2 n + 1 ,}} {{α}_{i , j , k , l}^{ref} ( {a}_{2} ( t ) )}^{i} {( \text{?} ( t ) )}^{j} {( {b}_{2 , ref} ( t ) )}^{k} {( \text{?} ( t ) )}^{l}$$

$$\text{?} \text{indicates text missing or illegible when filed}$$

To perform a prediction of an amplifier output signal for some new (not modeled) impedance condition for the device, we take the vector average of the gamma load trace for this impedance in the Smith chart and map it to the nearest reference load in the data set. We then apply the model coefficients for this reference to form the prediction of the amplifier output signal for that impedance. Essentially, this partitions the Smith chart into neighborhoods wherein a single model performs the most accurate results. The number of references poses a tradeoff between efficiency and accuracy, and it can be tailored according to the needs of the specific application.

### Measurement Technique for a Single Reference

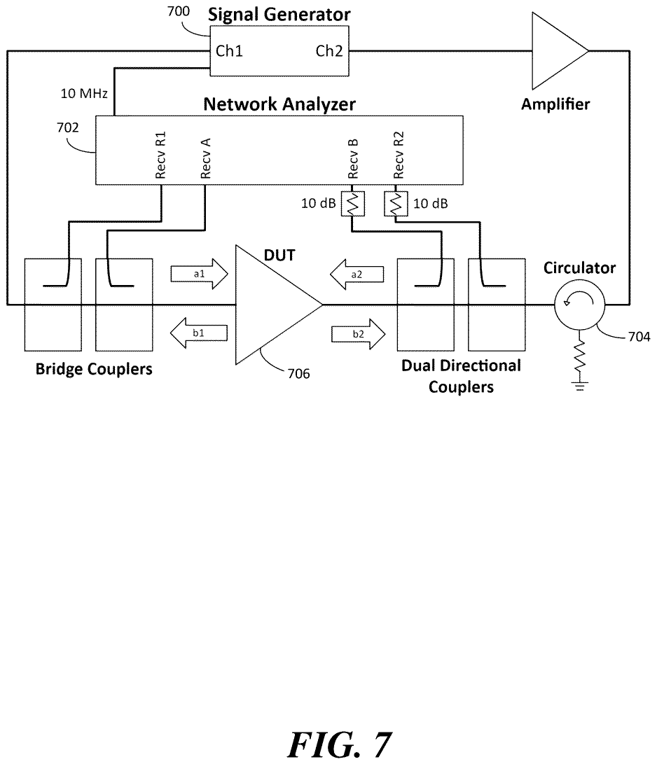

FIG. 7 illustrates an exemplary test setup for measuring amplifier output signals under different simulated load conditions. In FIG. 7, the test setup includes a dual channel signal generator 700. One channel is used to generate the amplifier input signal a₁(t). The other channel is used to generate the load impedance emulating signal a₂(t). A network analyzer 702 measures the amplifier output signal b_{2,ref}(t) and the load impedance emulating signal a₂(t). A circulator 704 functions as an isolator to allow the signals a₂(t) and b₂, ref(t) be measured independently. A device under test 706 is a power amplifier whose loadpull behavior is being measured and then modeled. In one example, Arbitrary Load Control (ALC) software on a Keysight Performance Network Analyzer (PNA-X), with a dual-channel Keysight VXG-C vector signal generator is used as the modulated sources, and a Skyworks power amplifier is used as the device under test (DUT).

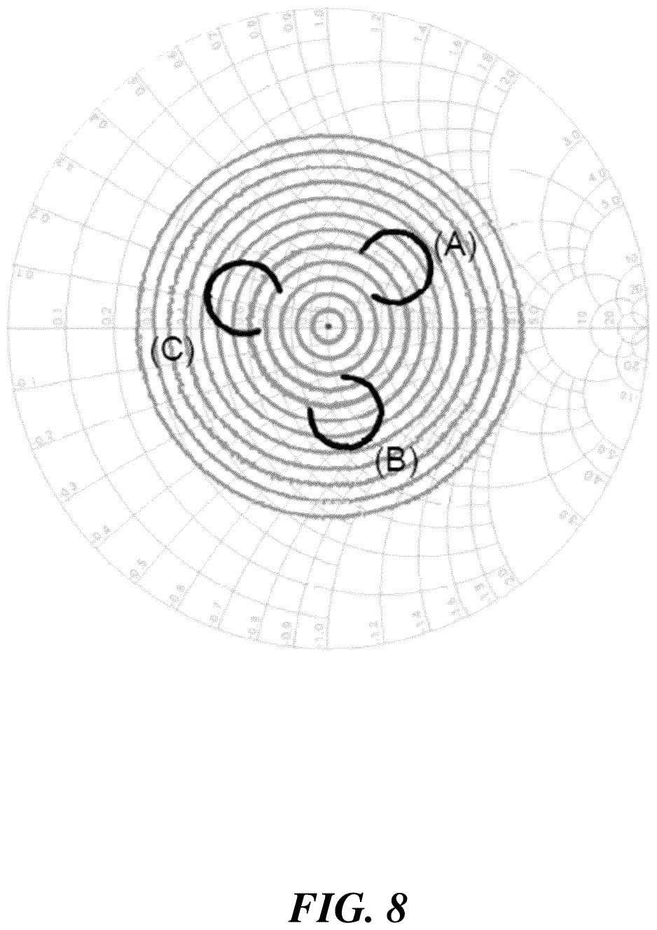

We selected a gamma load trace resembling a circle in the Smith chart (by introducing a long phase delay) for model extraction to essentially “de-correlate” the amplitudes of a₂(t) and b₂(t) at any fixed time t. Specifically, we wanted to collect data where the magnitude of a₂(t) is high while the magnitude of b₂(t) is low, and vice versa, to simulate a wide variety of impedance conditions. We sweep circles of varying radii in the Smith chart to acquire data for a variety of reflection magnitudes, shown in FIG. 8. This technique allows us to model the behavior of b₂(t) over a wide range of possible loads.

Due to our assumption that loadpull behavior is static and can be determined from instantaneous measurements of a₂(t) and b_{2,50}(t), it follows that the model behavior can be learned from modulated measurements taken at a high input power level and applied to measurements at lower input power levels because modulated measurements inherently contain time-domain data points with lower power amplitudes. Therefore, we extract the coefficients of the model from measurements taken at a single input power level of +4 dBm on 12 circles of varying size in the Smith chart centered around 50 Ohms.

The circular trace measurements used for model extraction were taken using a 100 MHz bandwidth flat multi-tone stimulus at a center frequency of 5 GHz. We then measured 3 test loads in the shape of arcs in the Smith chart at varying power levels for model validation. The model validation measurements were taken under the stimulus of a second 100 MHz flat multi-tone waveform generated from a different random seed so that the model extraction and validation waveforms are distinct. FIG. 8 shows the circular load traces used for model extraction (gray), the reference load used for capturing the measured memory effects (red), and the three test measurements, labeled A, B, and C, used for model validation (black). For each test load, we took measurements at 15 power levels logarithmically spaced between −10 and +4 dBm.

### Modeling Results Near 50 Ohms

We use a 7th order Volterra polynomial applied to the fundamental frequency behavior of a₂(t) and b_{2,50}(t) to learn the behavior of b₂(t). We then apply the coefficients from this model to predict the behavior of b₂(t) from our test measurements (the arcs measured under a new modulated stimulus).

When applying this technique to measured test data, we found that the simple Volterra polynomial model was robust enough to predict the output waveform of the device nearby to the reference impedance (50 Ohms), even for gamma load traces of different shapes.

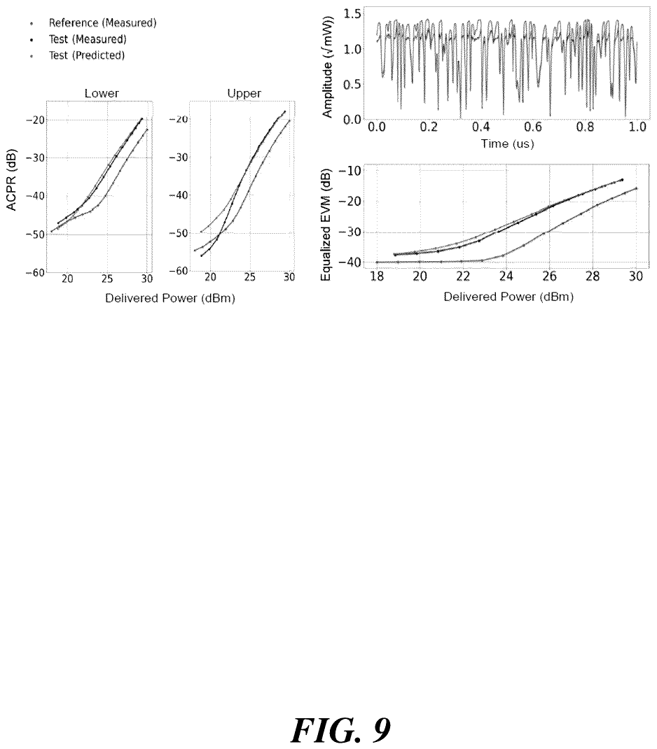

FIG. 9 shows close alignment of metrics (such as ACPR, EVM, and amplitude) for the measured and predicted b₂(t) for test measurement (A). The overlapping measured (black) and predicted (blue) traces indicate high accuracy in the prediction down to more than −40 dB of dynamic range, and that these traces are non-overlapping with the red reference trace demonstrates the non-triviality of the modeling problem.

### Modeling Using Multiple Reference Points

Farther away from the reference impedance used for training the model, predictions become less reliable. We implement our improvement to the model of using multiple reference points to improve predictive accuracy.

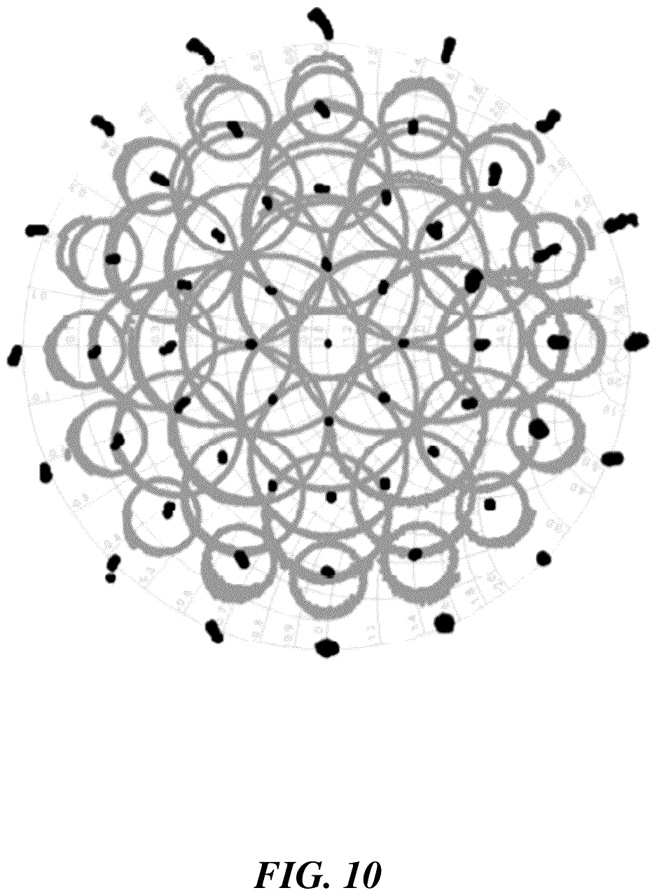

The data illustrated in FIG. 10 was taken from a similar wideband active loadpull setup with a different DUT and new modulated waveforms, also each 100 MHz flat multi-tones with random phase (and different seeds for model extraction and model validation). For model extraction, instead of circular traces in the Smith chart, we took arc-like measurements with dense coverage of the Smith chart where gamma load amplitude is less than 1 (gray), and our test loads are points distributed uniformly over the same area (black):

Using arcs instead of circles centered around the reference allows us to repurpose the same data for model extraction relative to multiple references, whereas the circles centered around the reference prefer accuracy around the center due to that point being included in both model extraction and validation.

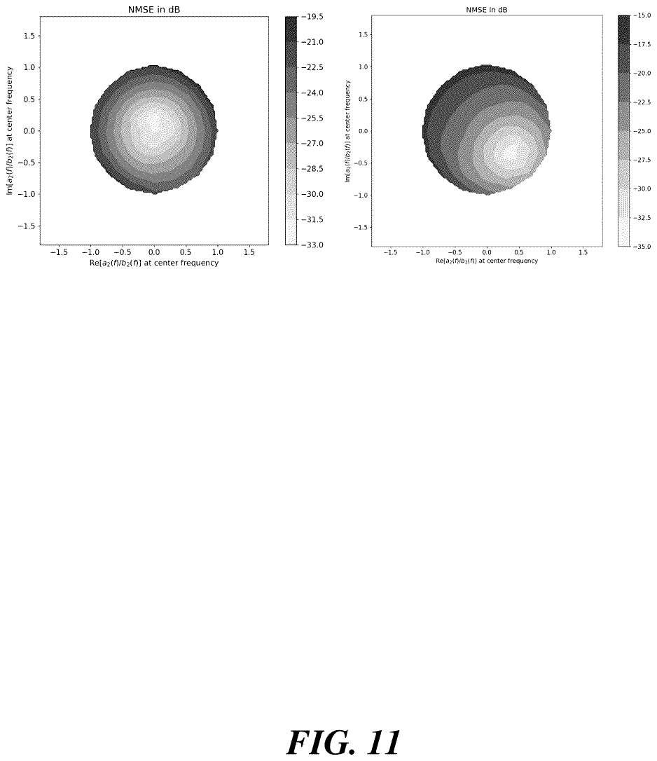

In FIG. 11 (left), we show a colormap of the NMSE between measured and predicted b₂(t) over the Smith chart when 50 Ohms is the reference load. If, however, we select a different reference load, the location of maximum accuracy in the Smith chart shifts towards this reference. We select a new reference load near Γ=+0.3−0.3j Γ and use the same model extraction and validation sets as above. The extracted model shows improved prediction accuracy in the area near the new reference load (FIG. 11 (right)).

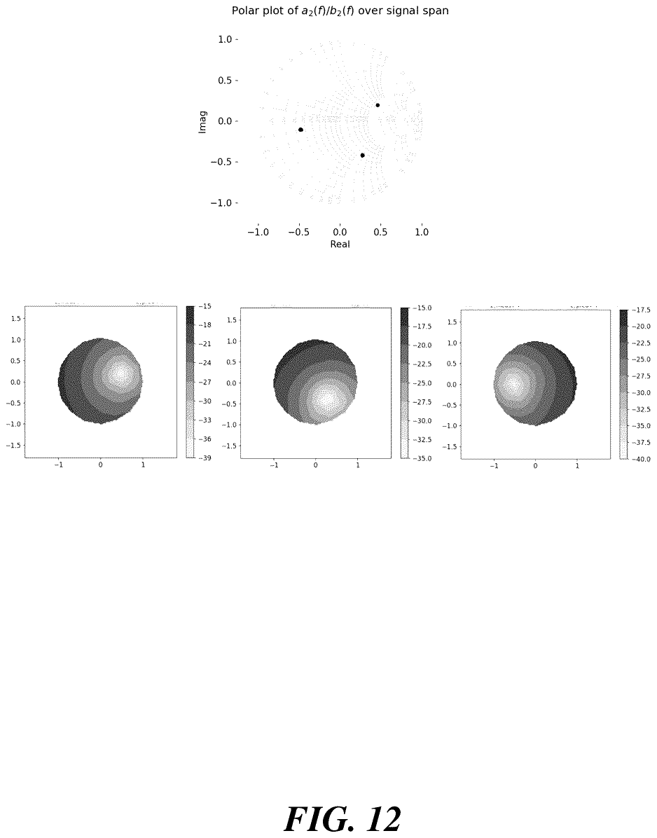

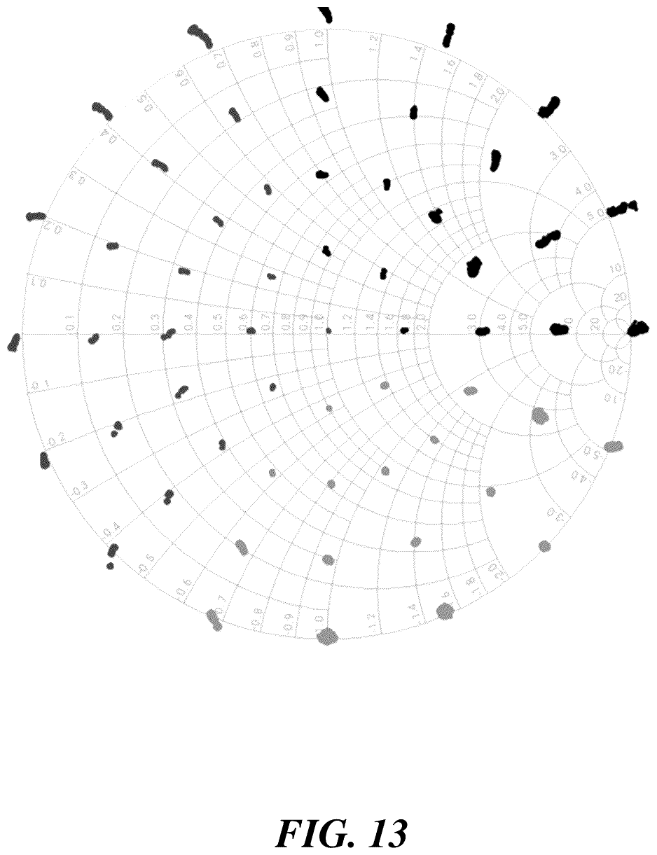

We perform similar tests for varying reference loads, and multiple model extraction and validation data sets as illustrated in FIG. 12. For each validation measurement (the black points shown in FIG. 10), we compute its vector average and select the model corresponding to the nearest reference. Using the 3 reference points shown in the FIG. 12, the validation data is divided into three subsets, shown in FIG. 13.

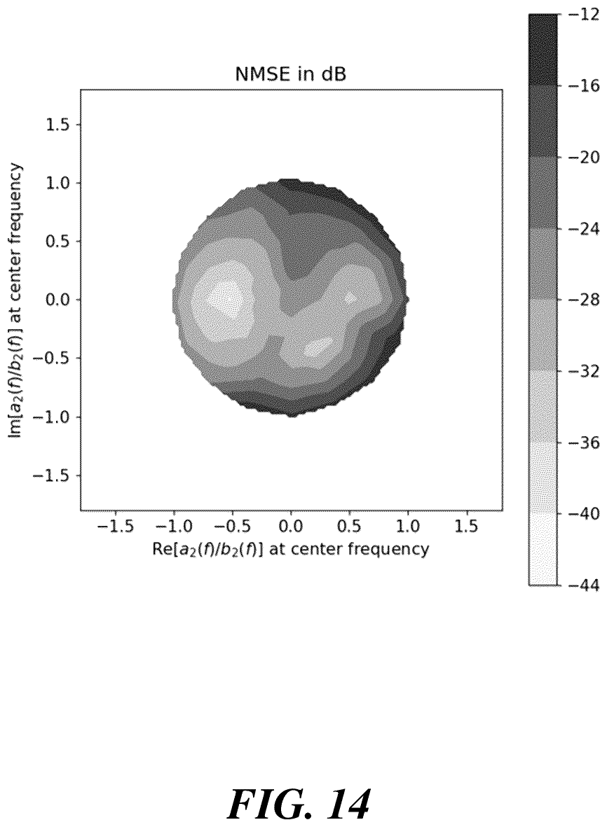

By training multiple models (each only a linear regression on a polynomial of degree 7) and applying them to each to the subsets of the validation set contained by “neighborhoods” within the Smith chart, we were able to predict the output of the amplifier with improved accuracy over a wider range of gamma load traces (up to a reflection coefficient of about 1), with poor prediction (>20 dB NMSE) only very close to perfect reflection. FIG. 14 illustrates NMSE of measured versus predicted b₂(t) using best reference for each measurement in validation set.

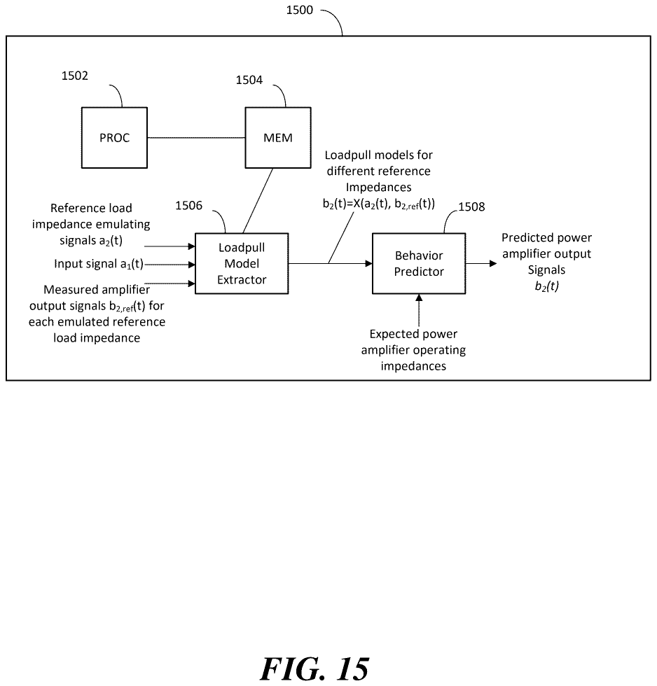

FIG. 15 is a block diagram of a system for modeling loadpull behavior of a power amplifier under modulated operating conditions. Referring to FIG. 15, a computing platform 1500 includes at least one processor 1502 and memory 1504. A loadpull model extractor 1506 generates loadpull models of a power amplifier for different reference impedances using the methodology described herein. That is, loadpull model extractor 1506 receives, as inputs, reference load emulating output signals a₂(t), an input signal a₁(t), and measured amplifier output signals b_{2,ref}(t) for each emulated load impedance. Loadpull model extractor 1506 then generates, for each reference impedance, a loadpull model for b₂(t) that depends only on a₂(t) and b_{2,ref}(t), where b_{2,ref}(t) is assumed to encapsulate memory effects of the input signal a₁(t). Once the loadpull models are generated, a loadpull behavior predictor 1508 uses the models to predict amplifier output signals b₂(t) under expected power amplifier operating impedances by selecting and using, for the expected amplifier operating impedances, a model whose reference impedance is closest to the expected power amplifier operating impedance or impedances. Loadpull model extractor 1506 and loadpull behavior predictor 1508 may be implemented using computer executable instructions stored in memory 1504 and executed by processor 1502.

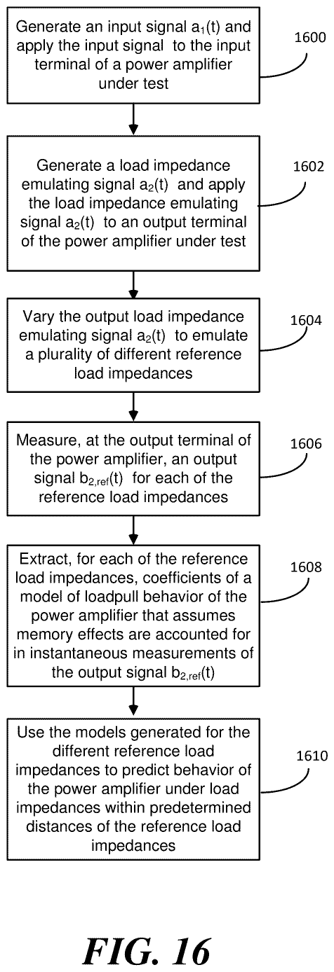

FIG. 16 is a flow chart illustrating a method for modeling loadpull behavior of a power amplifier under modulated operating conditions. Referring to FIG. 16, in step 1600, the process includes generating an input signal a₁(t) and applying the input signal a₁(t) to the input of a power amplifier under test. For example, a user may connect a real power amplifier to a signal generator and a network analyzer using a test configuration similar to that illustrated in FIG. 7 and use the signal generator to generate and apply a₁(t) to the amplifier input terminal.

In step 1602, the process further includes generating a load impedance emulating signal a₂(t) and applying the load impedance emulating signal a₂ (t) to an output terminal of the power amplifier under test. For example, the user may use the signal generator to apply a₂(t) to the output terminal of the power amplifier to simulate different load impedances.

In step 1604, the process further includes varying the load impedance emulating signal a₂(t) to emulate a plurality of different reference load impedances. For example, instead of applying a₂(t) to simulate a single matched load impedance, the user may use the signal generator to generate a₂(t) to simulate a plurality of different reference load impedances to divide the Smith chart into regions that simulate different reference load impedances.

In step 1606, the process further includes measuring, at the output terminal of the power amplifier, an output signal b_{2,ref}(t) for each of the reference load impedances. For example, the user may measure, using the network analyzer, b_{2,ref}(t) for each modeled output impedance.

In step 1608, the process further includes extracting, for each of the refence load impedances, coefficients of a model of loadpull behavior of the power amplifier that assumes memory effects are accounted for in instantaneous measurements of the output signal b_{2,ref}(t). For example, given the measured values of b_{2,ref}(t) and the known output impedances modeled by a₂(t) for reference load impedances, model extractor 1506 may calculate coefficients of a model that models the relationship between b₂(t), a₂(t) and b_{2,ref}(t). In the example described above, the model is a Volterra polynomial model.

In step 1610, the process further includes using the models generated for the different reference load impedances to predict behavior of the power amplifier under load impedances within predetermined distances of the reference load impedances. For example, to simulate the behavior of a power amplifier, the user may select the amplifier behavioral model that is closest to the operating impedance or range of operating impedances of a power amplifier and use the model to calculate the predicted amplifier output signal b₂(t) given the output impedances simulated by a₂(t) and the value of b_{2,ref} (t) measured for the reference load impedance

The disclosure of each of the following references is incorporated herein by reference in its entirety.

### REFERENCES

[1] David E. Root, Jan Verspecht, Jason Horn, and Mihai Marcu, “X-parameters—Characterization, Modeling, and Design of Nonlinear RF and Microwave Components,” Cambridge University Press, 2013.
[2] AMCAD Engineering, “Behavioral Model of High Power GaN HEMTS for RF Doherty Amplifier”, Technical Note 2018.
[3] Jan Verspecht, “Time Alignment based on Frequency Domain Processing,” Keysight White Paper, 2020.
[4] Kassem El-Akhdar, Damien Gapillout, Christophe Mazière, Sébastien Mons, and Edouard Ngoya, “A Phase Reference Standard Free Setup for Two-path Memory Model Identification of Wideband Power Amplifier,” Proceedings of the 89th ARFTG Conference, 2017.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for modeling loadpull behavior of a power amplifier under modulated operating conditions, the method comprising:
receiving, as inputs, measured values of an amplifier output signal b_{2,ref}(t) for a plurality of different reference load impedances and a load impedance emulating signal a₂(t) used to emulate the reference load impedances;
extracting, for each of the reference load impedances, a model of loadpull behavior of the power amplifier that assumes memory effects are accounted for in instantaneous measurements of the amplifier output signal b_{2,ref}(t); and
using the models generated for the different reference load impedances to predict behavior of the power amplifier under load impedances within predetermined distances of the reference load impedances.

2. The method of claim 1 comprising generating and applying an input signal a₁(t) to an input terminal of the power amplifier, generating and applying the load impedance emulating signal a₂(t) for each of the reference load impedances to an output terminal of the power amplifier, and measuring the values of the output signal b_{2,ref}(t) at the output terminal of the power amplifier.

3. The method of claim 2 comprising varying the load impedance emulating signal a₂(t) to emulate a plurality of different reference load impedances by selecting the different reference load impedances corresponding to different expected operating impedances of the power amplifier.

4. The method of claim 1 wherein extracting the model for each of the reference load impedances includes extracting coefficients of a polynomial model for each of the reference load impedances.

5. The method of claim 4 wherein the polynomial model comprises a Volterra polynomial model.

6. The method of claim 1 wherein the predetermined distances are differences in magnitudes and phases between the reference load impedances for each model and the load impedances for which the behavior of the power amplifier is being predicted.

7. The method of claim 6 wherein the predetermined distances are measurable using a Smith chart.

8. The method of claim 1 wherein using the models generated for the different reference load impedances to predict behavior of the power amplifier under operating load impedances within predetermined distances of the reference load impedances includes, for an operating load impedance for which behavior of the power amplifier is being predicted, selecting a model corresponding to a reference load impedance having a closest distance to the operating load impedance of the power amplifier.

9. The method of claim 1 wherein using the models generated for the different reference load impedances to predict behavior of the power amplifier under operating load impedances within predetermined distances of the reference load impedances includes, for a gamma load trace representing operating load impedances for a plurality of different frequencies, computing a vector average impedance of the gamma load trace, and selecting a model corresponding to a reference load impedance having a closest distance to the vector average impedance.

10. A system for modeling loadpull behavior of a power amplifier under modulated operating conditions, the system comprising:
a computing platform including at least one processor and a memory;
a model extractor implemented by the at least one processor for receiving, as inputs, measured values of an amplifier output signal b_{2,ref}(t) for a plurality of different reference load impedances and a load impedance emulating signal a₂(t) used to emulate the reference load impedances and extracting a model of loadpull behavior of the power amplifier that assumes memory effects are accounted for in instantaneous measurements of the amplifier output signal b_{2,ref}(t); and
a loadpull behavior predictor implemented by the at least one processor for using the models generated for the different reference load impedances to predict behavior of the power amplifier under load impedances within predetermined distances of the reference load impedances.

11. The system of claim 10 comprising a signal generator for generating and applying an input signal a₁(t) to an input terminal of the power amplifier and for generating and applying the load impedance emulating signal a₂(t) to an output terminal of the power amplifier.

12. The system of claim 11 comprising a network analyzer for measuring the amplifier output signal b_{2,ref}(t).

13. The system of claim 11 wherein the signal generator is configured to vary the load impedance emulating signal a₂(t) to emulate the plurality of different reference load impedances by selecting the different reference load impedances corresponding to different expected operating impedances of the power amplifier.

14. The system of claim 10 wherein the model comprises a polynomial model.

15. The system of claim 14 wherein the polynomial model comprises a Volterra polynomial model.

16. The system of claim 10 wherein the predetermined distances are differences in magnitudes and phases between the reference load impedances for each model and the operating impedances being modeled.

17. The system of claim 16 wherein the predetermined distances are measurable using a Smith chart.

18. The system of claim 10 wherein the model extractor is configured to, for an operating load impedance for which behavior of the power amplifier is being predicted, select a model corresponding to a reference load impedance having a closest distance to the operating load impedance of the power amplifier.

19. The system of claim 10 wherein the loadpull behavior predictor is configured to, for a gamma load trace representing operating load impedances for a plurality of different frequencies, compute a vector average impedance of the gamma load trace, and select a model corresponding to a reference load impedance having a closest distance to the vector average impedance.

20. A non-transitory computer readable medium having stored thereon executable instructions that when executed by a processor of a computer control the computer to perform steps comprising:
receiving, as inputs, measured values of an amplifier output signal b_{2,ref}(t) for a plurality of different reference load impedances and a load impedance emulating signal a₂(t) used to emulate the reference load impedances;
extracting, for each of the reference load impedances, a model of loadpull behavior of a power amplifier that assumes memory effects are accounted for in instantaneous measurements of the output signal b_{2,ref}(t); and
using the models generated for the different reference load impedances to model behavior of the power amplifier under load impedances within predetermined distances of the reference load impedances.
